(19) United States
(12) Patent Application Publication
(10) Pub. No.: US 2014/0054248 A1
(43) Pub. Date: Feb. 27, 2014

(54) TREE DISPLAY STAND

(71) Applicant: Poly-Tex Inc., Castle Rock, MN (US)

(72) Inventor: Brian Crombie, Castle Rock, MN (US)

(73) Assignee: Poly-Tex Inc., Castle Rock, MN (US)

(21) Appl. No.: 13/974,039

(22) Filed: Aug. 22, 2013

Related U.S. Application Data
(60) Provisional application No. 61/691,798, filed on Aug. 22, 2012.

(51) Int. Cl. A01G 17/04

(52) U.S. Cl. CPC A01G 17/04
USPC 211/49.1

(57) ABSTRACT

A tree display for displaying potted trees. The tree display includes a longitudinal beam supported vertically above a support surface by beam supports. A plurality of tree supports are longitudinally spaced along the longitudinal beam. The tree supports include a tree restraint which removably restrains a trunk or stem of the tree.

### BACKGROUND

When displaying trees at nurseries or retail outlets, it is desirable to keep the trees displayed in an aesthetically pleasing and organized manner. It is also desirable to support the trees in a manner that will prevent them from tipping over in the event of high winds while also allowing the trees to be easily removable from the display for better viewing and purchase by the customer without the need for assistance from nursery or store employees.

### BRIEF DESCRIPTION OF THE DRAWINGS

FIG. 1 is a perspective view of one embodiment of a tree display stand.

FIG. 2 is a perspective view of another embodiment of a tree display stand.

FIG. 3 is an enlarged perspective view of an embodiment of the tree restraint at one end of the hook rod shown in the open position.

FIG. 4 is an enlarged perspective view of the tree restraint of FIG. 4 shown in the closed position.

FIG. 5 is an enlarged perspective view of an embodiment of the hook rod attachment.

FIG. 6 is an enlarged partial perspective view of an embodiment for the frame leg support attachment.

FIGS. 7-10 are perspective views illustrating alternative embodiments of a tree restraint.

### DESCRIPTION

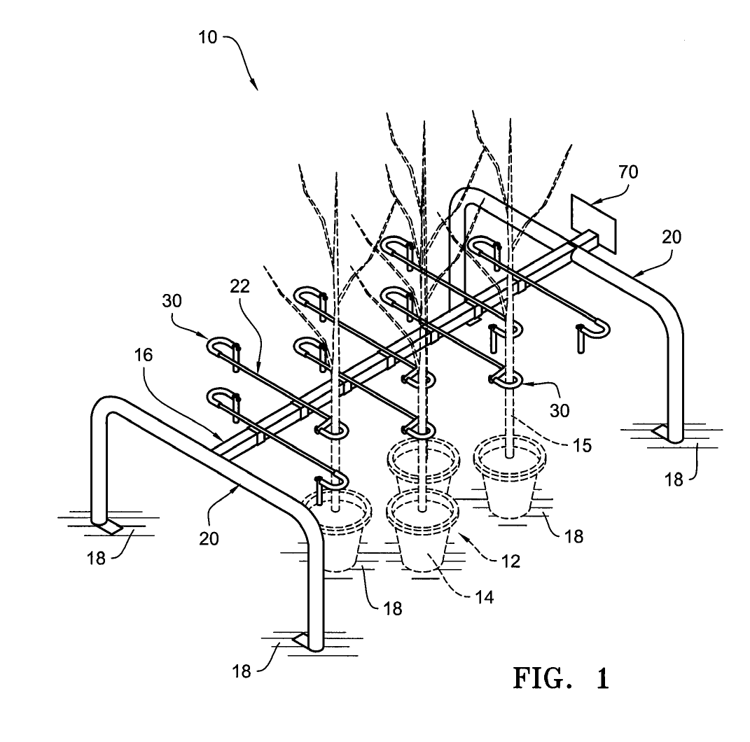

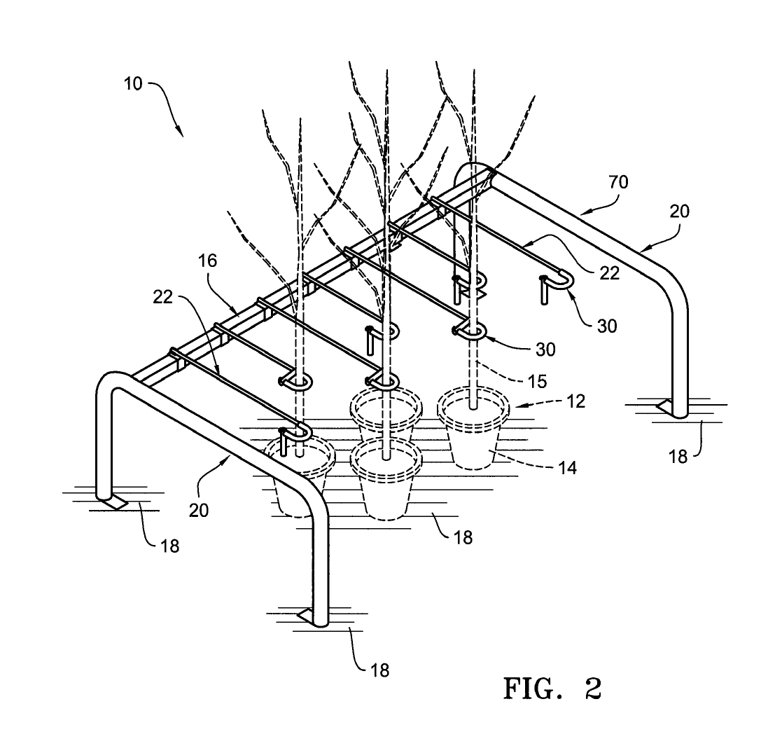

Referring now to the drawings, wherein like reference numerals designate identical or corresponding parts throughout the several views, FIG. 1 is a perspective view illustrating one embodiment of a tree display stand 10 for displaying potted trees 12 at a nursery or other retail outlet. Although the term “tree” is used throughout this specification in describing one of the intended uses for which the display stand 10 is particularly adapted, it should be understood that the term “tree” is intended to include or refer to any type of plant within a pot 14 that has a vertically oriented trunk or stem 15. FIG. 2 is a perspective view of another embodiment of a tree display stand 10.

The tree display stand 10 includes a longitudinal beam 16 supported a distance vertically above the ground or other support surface 18 by beam supports 20. A plurality of tree supports 22 are preferably movably secured to the longitudinal beam 12 and are spaced longitudinally along the length of the longitudinal beam 12.

The tree supports 22 extend outwardly laterally or transverse to the longitudinal beam. The tree supports 22 comprise an elongated rod 32, preferably fabricated from a corrosion resistant bar stock such as galvanized steel or aluminum. Each tree support 22 includes a tree restraint 30 on at least one end. In FIG. 1, both ends of the tree support 22 include a tree restraint 30. In FIG. 2, only one end of the tree support 22 includes a tree restraint 30. The longitudinally spaced tree supports 22 are preferably laterally offset from adjacent tree supports to allow sufficient room for the pots 14 when the trunks 15 of the trees 12 are received in the tree restraints 30.

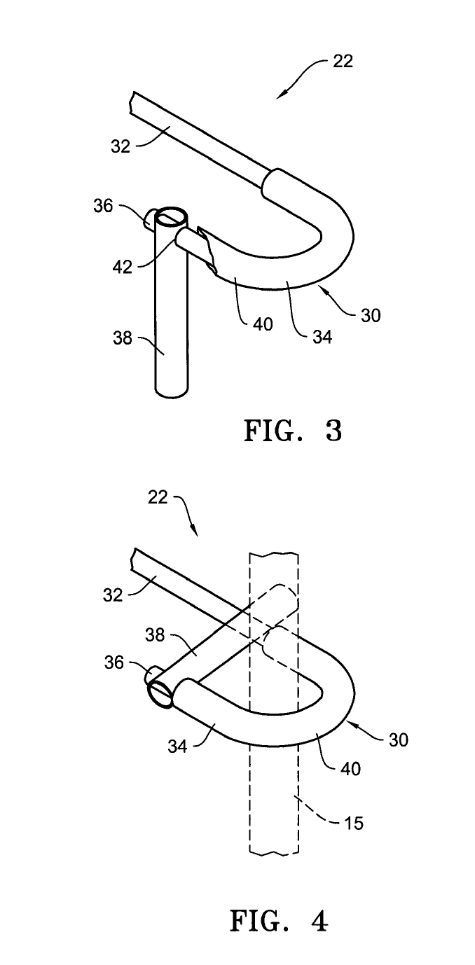

The tree restraints 30 are sized to receive the trunk 15 of the potted tree 12 and permit the tree trunk to be removably restrained. In the embodiment of FIGS. 3 and 4, the tree restraint 30 comprises a hook 34 at the end of the rod 32. The free end 36 of the hook 34 preferably includes a movable arm 38. The movable arm 38 is movable between an open position (FIG. 3), wherein the tree can be removed from the tree restraint 30, and a closed position (FIG. 4) wherein the tree is restrained by the tree restraint 30. The hook 34 is preferably padded with foam rubber or other material 40 to prevent the tree trunk from abrasion or scaring during movement of the tree as it is being placed in or removed from the display stand 10 or from movement of the tree due to wind or due to the tree or pot 14 being bumped or jostled while other trees in the display stand are being added or removed.

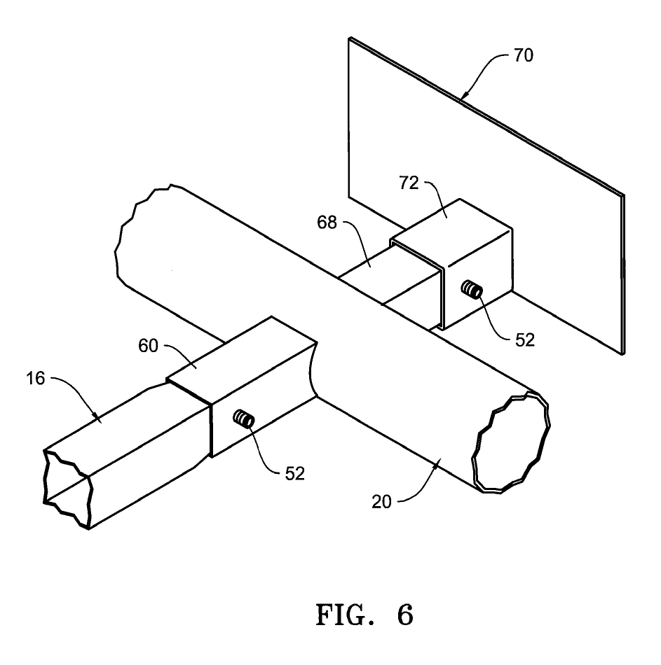

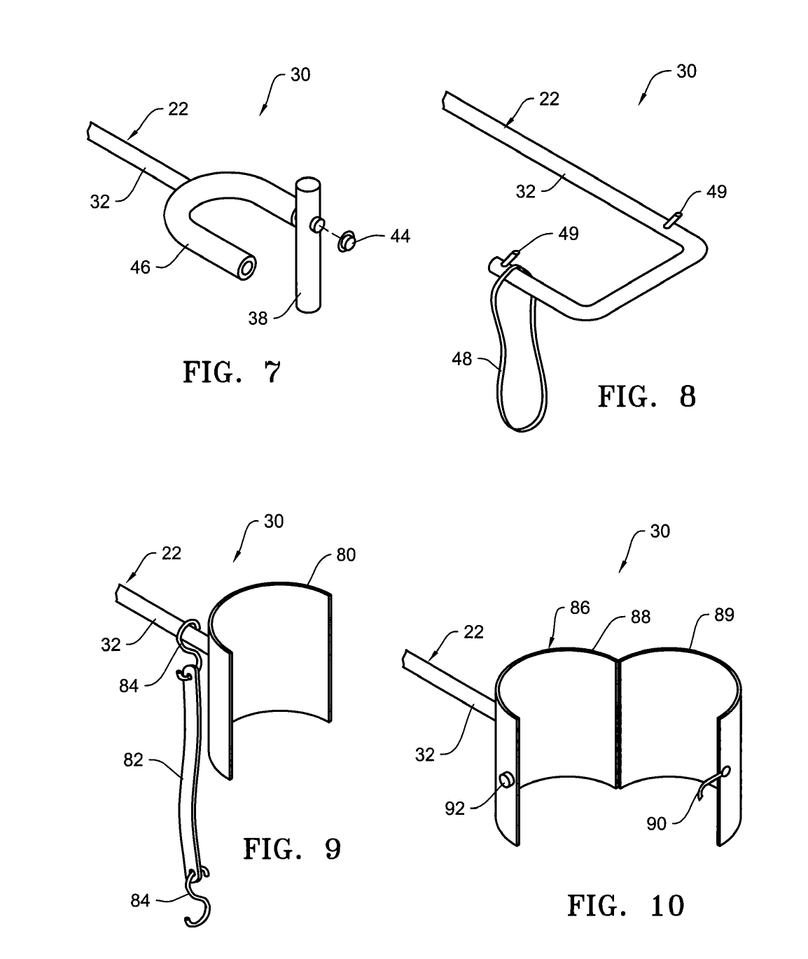

The movable arm 38 may be rotatably attached to the free end 36 of the hook 34 in any suitable manner. In the embodiment illustrated in FIGS. 3 and 4, the arm 38 is illustrated as being constructed of a tubular member through which a hole 42 is drilled to rotatably receive the free end 36 of the hook. The arm 38 is preferably retained on the free end of the hook 36 by any suitable means. For example the free end 36 of the hook may be flattened or enlarged to prevent the arm 38 from sliding off the free end 36 while still permitting the arm 38 to be rotatable. As another example, the arm 38 may be rotatably retained on the free end 36 of the hook 34 by drilling a hole in the free end 36 of the rod 32 that projects through the hole 42 and inserting a cotter pin (not shown) through the drilled holed. In yet another example, a press-on cap 44 (FIG. 7) may be used to retain the arm 38 on the free end 36 of the rod 32.

FIG. 7 illustrates another embodiment of a tree restraint 30, which is substantially similar to the embodiment of FIGS. 3 and 4 except that rather than a hook 34, a U-shaped member 46 is secured to the end of the rod 32. A movable arm 38 is secured to one leg of the U-shaped member 46 by a press-on cap 44. Similar to the embodiment of FIGS. 3 and 4, the arm is pivotably movable to retain the tree trunk within the U-shaped member 46.

In the embodiment of FIG. 8, tree restraint 30 comprises a U-shaped bend in the end of the rod 32. To removably restrain the tree trunk (not shown) within the U-shaped bend an elastic band 48 may be used. Pegs 49 are welded or secured to the rod 32 about which the elastic band 48 may stretched and hooked to retain the tree trunk within the U-shaped bend.

In the embodiment of FIG. 9, tree restraint 30 includes a half-pipe member 80 which may be fabricated from a short length of pipe that has been cut in half longitudinally and secured to the end of the rod 32. A conventional bungee cord an elastic strap 82 having a pair of hooks 84 at each end may be used to restrain the tree trunk (not shown) within the half-pipe member 80 by hooking one of the hooks 84 around the rod 32 and wrapping the strap over the open end of the hal-pipe member 80 with the tree trunk therein and hooking the other hook in the opposite direction over the rod 32.

In the embodiment of FIG. 10, tree restraint 30 includes a hinged pipe member 86. Similar to the embodiment of FIG. 9, the hinged pipe member 86 may be fabricated from a short length of pipe cut in half longitudinally. A first half 88 of the hinged pipe member 86 is secured to the rod 32. The second half 89 of the hinged pipe member 86 is hingedly secured along one side to the first half 88, permitting the two halves 88, 89 to come together to form a sleeve about the tree trunk (not shown). The two halves 88, 89 of the hinged pipe member may be held together by a hooked latch 90 pivotally secured to one of the halves which hooks around a peg 92 on the other half.

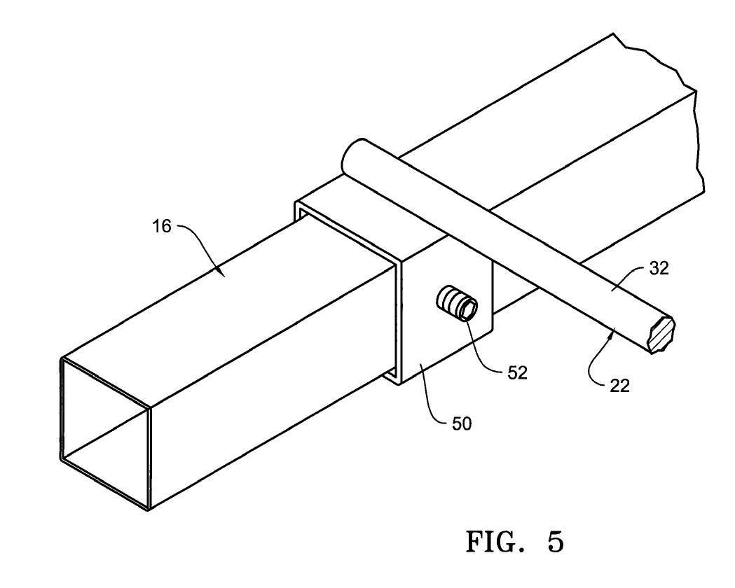

The tree supports 22 are preferably secured to the longitudinal beam 16 that allows the tree supports to be movably positioned longitudinally along the longitudinal beam 16 to accommodate different sizes of pots 14 or to otherwise vary the spacing of the trees 12. In one embodiment as best illustrated in FIG. 5, the longitudinal beam 16 is constructed of square tubular stock, preferably fabricated from corrosion resistant material such as galvanized steel or aluminum. A saddle 50, made of tubular stock and is sized to receive the longitudinal beam. The saddle 50 is preferably drilled and tapped to receive a threaded connector 52 which may be tightened to secure the saddle 50 in place or loosened to permit the sleeve to be moved longitudinally along the longitudinal beam 16. The rod 32 of the tree support 22 is preferably welded to the saddle 50. It should be appreciated that the saddle 50 is preferably fabricated from material that is galvanically compatible with the longitudinal beam 16.

FIG. 6 is a detailed, partial perspective view illustrating an embodiment for attaching the longitudinal beam 16 to the beam supports 20. The beam support 20 may be fabricated from any suitable material, but is shown in FIGS. 1, 2 and 6 as being fabricated from round tubular material that is bent or rolled into a U configuration to form a horizontal member 60 and two downwardly extending legs 62, 64, having a length suitable to support the longitudinal beam 16 a desired height above the support surface 18 to receive the pots 14 containing the trees 12 which may sit directly on the ground surface or on pallets or other support members. Stub sleeves 66, 68 are preferable welded to the horizontal member 60 to project perpendicular thereto. The stub sleeves 66, 68 are preferably fabricated from tubular stock to receive the end of the longitudinal beams 16. The ends of the longitudinal beam may be crimped to be received into the stub sleeves 66, 68 or the stub sleeves 66, 68 may be sized from larger tubular stock which is able to receive the ends of the longitudinal beam 16 without the need for crimping. The stub sleeves 66, 68 are preferably drilled and tapped to receive a threaded connector for securing the longitudinal beam within the stub sleeves 66, 68. It should be appreciated that longitudinal beams 16 may be attached to each side of the horizontal member 60 using the stub sleeves 66, 68 to construct a display stand 10 that is modular and variable in length by attaching multiple longitudinal beams end-to-end to the beam supports 20.

As shown in FIG. 6, a sign 70 may be attached to one of the stub sleeves 66, 68. The sign may designate the variety of the trees within the display stand 10 or the sign may include other relevant information. The back of the sign 70 preferably includes a mounting sleeve 72 sized to receive the stub sleeve 66, 68 or to be received within the stub sleeves 66, 68. The mounting sleeve 72 is also preferably drilled and tapped to secure the mounting sleeve 72 to the stub sleeve 66, 68.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A tree display for displaying potted trees, comprising:
a longitudinal beam supported vertically above a support surface by beam supports;
a plurality of tree supports longitudinally spaced along said longitudinal beam, said tree supports having a tree restraint which removably restrains a trunk or stem of the tree.

2. The tree display of claim 1, wherein said tree restraint includes a hook and a movable arm movable between an open position wherein the tree trunk or stem may be removed from the hook end, and a closed position wherein the tree trunk or stem is restrained within the hook.

3. The tree display of claim 1, wherein said tree restraint includes a U-shaped member and a movable arm movable between an open position wherein the tree trunk or stem may be removed from the U-shaped member, and a closed position wherein the tree trunk or stem is restrained within the U-shaped member.

4. The tree display of claim 1, wherein said tree restraint includes a bend at end of the tree support and an elastic band which removable spans said bend for removable retaining the tree trunk or stem within the bend.

5. The tree display of claim 1, wherein said tree restraint includes a half-pipe member secured to an end of the tree support and an elastic band with hooks which hook about the tree support for removable retaining the tree trunk or stem within the half-pipe.

6. The tree display of claim 1, wherein said tree restraint includes a hinged-pipe member with a first half secured to an end of the tree support and a second half hingedly secured to the first half to form a sleeve around the tree trunk or sleeve, and further comprising a latch to secure the halves together for removable retaining the tree trunk or stem between the hinged halves.

7. The tree display of claim 1, wherein the tree restraints of the plurality of tree supports are laterally offset from the longitudinally adjacent tree restraints.

8. The tree display of claim 1, wherein the tree supports extend laterally to said longitudinal beam.

9. The tree display of claim 1, wherein the tree supports are adjustably movable along said longitudinal beam.

10. The tree display of claim 9, wherein the tree supports extend laterally from opposing sides of said longitudinal beam.

11. The tree display of claim 9, wherein the tree supports extend laterally from only one side of said longitudinal beam.
